(19) United States
(12) Patent Application Publication
(10) Pub. No.: US 2010/0321745 A1
(43) Pub. Date: Dec. 23, 2010

(54) Portable battery powered multi-media duplex scanner with optional docking station

(75) Inventor: Ron Van Os, Morrison, CO (US)

Correspondence Address: Ron van Os, 8016 S. Deer Creek Canyon Rd, Morrison, CO, 80465, US

(73) Assignee: Visioneer, Inc.

(21) Appl. No.: 12/456,612

(22) Filed: Jun. 19, 2009

(51) Int. Cl. H04N 1/04

(52) U.S. Cl. 358/498

(57) ABSTRACT

The invention relates to a small, portable, duplex scanner which is fully battery powered. The scanner will accept various media including standard size paper documents, embossed credit cards, ID type cards, and compact disc type media. The scanner batteries are charged via connection to any power providing device, such as a small cell phone type AC adapter or via the docking station when the scanner is docked. Power management is optimized to provide efficiency of battery usage and battery life. Assisted de-skew is a novel feature wherein LED's direct a user to adjust media insertion for a perfect media feed.

### FIELD

The invention relates to a small, portable duplex scanner which is fully battery powered. The scanner will accept various media including standard size paper documents, credit cards or other ID type cards, and compact disc type media. The scanner offers approximately one month of power, or 100 pages, derived from lithium ion batteries. No additional power source is required. Battery charging is accomplished by connection to suitable power source to provide charge. Scanned data may be transferred to a host via wireless methods, direct connection, or removable media such as a flash drive. An optional docking station which provides automatic document feed (ADF) to the scanner, combined with printing, faxing, and copying multi-page scans is also a unique component of the invention.

### BACKGROUND OF THE INVENTION

The invention most closely corresponds with USPTO Class 358/1.5 wherein Class 358 includes communication or reproduction of a static image or sequence of static images in which the local light, or density variations composing the image do not vary with time. The sub-class includes subject matter wherein the position or speed of the marking means or image medium modifies the presentation of the data.

In its simplest form, the invention comprises a unique portable duplex scanner that requires no external power source, and which accommodates various media such as paper documents, ID cards, embossed credit cards, and compact discs while self managing power consumption to optimize battery life. Wireless transfer of scanned data is also accommodated. An optional docking station which provides automatic document feed (ADF) for multi-page scanning, printing, faxing and copying is also a unique component of the invention.

Current scanners which claim to be “portable” or “battery-powered” still require some connection to a host, i.e. a computer or host device, or are small hand-held scanners which cannot accept any media. In particular, Chen (U.S. Pat. No. 6,031,636), which is hereby specifically incorporated by reference for all that it discloses, requires connection to a host computer, and thus is not truly “battery powered”. Kochis (U.S. Pat. No. 5,381,020), which is hereby specifically incorporated by reference for all that it discloses, is a hand-held scanner which a user must run over a document to be scanned, and does not accept any media. None of the prior art provides all of the features of the present invention including true battery powered operation, multi-media scanning, assisted de-skew, or the option of a docking station for multiple page scanning.

### THE INVENTION

### Summary, Objects and Advantages

Business is conducted more and more outside of a traditional office. As a result, greater mobility and functionality is required from devices used to accomplish business tasks. Scanners which are truly portable are a long felt need in the art. However, a truly portable scanner should require no external power source. The present invention accomplishes such portability in a small, easy to use, full-featured device.

The inventive scanner is small enough to fit inside a briefcase or laptop case, and can scan not only paper documents, but also ID cards and embossed credit cards. A medical office, for example, might need to check patients in who cannot stand at a counter to complete paperwork. The user can take the inventive scanner to a seated patient, scan their ID card and any other documents the patient might need copies of themselves. The user then returns to their computer and can transfer the scanned images into their system, print them out, and provide a copy to the patient. This data transfer can occur without external connection via a wireless link such as Bluetooth, wireless USB, and wi-fi.

The lithium ion batteries which power the scanner are charged via a connection to a power providing source. This source can be any device which can supply power such as an AC adapter which plugs into a wall outlet, or a computer which itself provides power. All that is required for battery charging is a transfer of power from any capable device or outlet to the scanner. One such device is provided with the scanner, and roughly the size of a cell phone wall charger unit.

The inventive software which accompanies the scanner adjusts power draw based upon the charging device connected. For instance, if connected to a laptop to charge the scanner battery, the software detects such and adjusts milliamp draw so that the laptop battery itself is not unduly drained. Similar adjustments are made if the software detects charging is derived from an AC source. Power management is inherent to the charge function so that the batteries are properly charged and discharged to preserve the lithium ion battery life.

Another power management feature is applied when the software detects the scanner is in idle mode. The scanner buttons are active, but no operation is occurring. Thus, the microprocessor on the scanner circuit board adjusts supply voltages, powers down unnecessary subunits, and lowers the clock. This self-management of power consumption preserves the scanner battery life so that a user attains optimal run time from the scanner.

Storage of data may be accomplished via an on-board flash memory resident on the scanner's PCB. Data can be transferred as a user wishes via the wireless connection, or via a USB connection. Data storage can also be accomplished via removable storage devices such as a flash drives and SD/MMC cards. These features are for data transfer only, and do not power the scanner. If the scanner is not powered by the batteries, i.e. is only connected to a charging source, the scanning function will not be able to be performed. The scanner will then only allow a user to obtain data stored on the scanner's resident memory chip or removable storage media. When in wireless mode, scanned images may be transferred to the user's computer or mobile device, such as an i-Phone or Blackberry, when in wireless range.

Feeding media is typically an issue in scanners with relatively unguided or open paper inserts. In such an instance, straight feeding of the media is a problem. If media is inserted at an improper angle, the paper, for instance may become skewed and cause a paper jam or an unacceptable scan. The inventive scanner solves this problem with the placement of analog paper proximity sensors across the input path which help a user visually confirm they are feeding the media in with minimal skew. For purposes of this Application, this solution is known as “assisted de-skew”. When media is inserted at a skewed angle, an LED will illuminate on the left side to indicate the user needs to angle the media towards the right, and vice versa. When the paper sensors determine the media is inserted straight, neither skew alert light will be illuminated, and the media will be drawn through the scan path and will maintain a straight paper path throughout the scan. This eliminates the need for software de-skew which requires data intensive processing, i.e. increased power. Since the inventive de-skew is performed upon media acquisition, and not reliant on software, such a feature provides optimum OCR recognition, file size reduction, increased storage space, scan speed increase, and faster transfers when using slow or low bandwidth transfer methods.

Dual rollers are positioned on a pivot axis to allow acceptance of varying thicknesses of media. Upon insertion of media, the paper feed path adjusts to accept media recognizing that such media is a paper document or a thicker media such as a credit card or ID card. The front and rear roller sets smoothly guide the media through the scan path without stutter or stall. A single motor provides both the driving mechanism to power the auto thickness adjustment, and to feed the media through the scanner. The scanner can accommodate media thicknesses up to 2 mm.

Paper or media output is accomplished either via a paper return which will return the media towards the user, or a straight path wherein the media is ejected at the rear of the scanner. Since the assembly pivots allowing the rollers to part for thicker media, the paper return will automatically move out of the way and allow thicker media to exit the rear of the scanner. Optical paper sensors assist in determining the width of the inserted media, while the automatically adjusting feed rollers accept the media based upon its thickness, and the drive proceeds through the scan path. This adjustment is transparent to the user and occurs in a few milliseconds. In the event of a credit card or ID card scan, the card size is automatically detected by the inventive software and the card will be returned directly back to the user from the point of insertion. This is optimal since a hard plastic card will not bend to be driven through a standard paper return such as with a paper document. Further, a user will not have to fumble behind the scanner to retrieve a scanned card.

The inventive scanner also contains a host USB port wherein a user can connect a device such as a flash drive or printer directly to the scanner. Thus, the scanner provides power to the connected external device from its batteries, and a user may scan and print a document essentially in one step. The scanner serves as a host to power or charge connected external devices within the power ranges required by the device, and provided by the scanner as detailed herein.

In summary, the inventive scanner solves a need in the industry by providing truly portable duplex scanning capability in a small device which requires no external power source or physical connection to a host to operate. Battery life is greater than most users would deem available, and data transfer can be performed at the user's convenience via wireless methods, cable, or devices such as memory cards and flash drives.

### BRIEF DESCRIPTION OF THE DRAWINGS

The invention is described in further detail by reference to the drawings in which:

FIG. 1; depicts a full angled front view of the scanner.

FIG. 2; is a flowchart of the power management function.

FIG. 3; is a functional view of the media transport arrangement.

FIG. 4; is a diagram of the roller arrangement.

FIG. 5; is an illustration of the paper return in open and closed positions;

FIG. 6 is a schematic of the paper presence detection; and

FIG. 7; is the optional scanner docking station.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in seven relatively simple figures; although sufficiently complex as to illuminate to one skilled in the art of such software architecture, programming, and computer operations a viable method for making or using said invention.

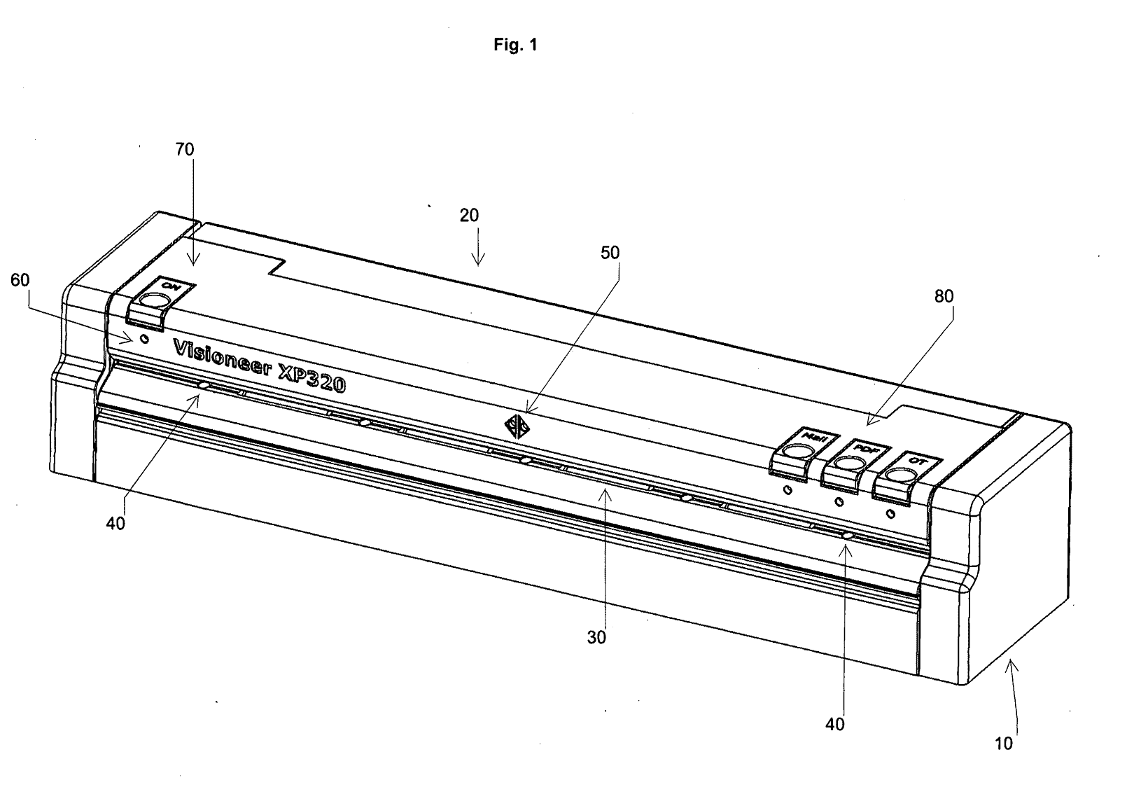

FIG. 1 is a full front view of the scanner. The casing 10 is constructed of plastic. The paper return 20 is illustrated as showing a document being returned via the rear, thus we can consider the paper return to be in the closed position. Also illustrated on this Figure is the paper input 30. Paper sensors 40 are located along the media insert. A set of lights 50 which provide guidance for the self-assisted de-skew illuminate across the front top of the paper feed. A power light 60 is positioned below the power button 70 and blinks to indicate the scanner is charging or remains steadily illuminated to indicate the scanner is in battery power mode. A set of 3 lighted buttons 80 are directed toward the output function, i.e. email, PDF or copy for example, and illuminate upon the user's selection by depression of same.

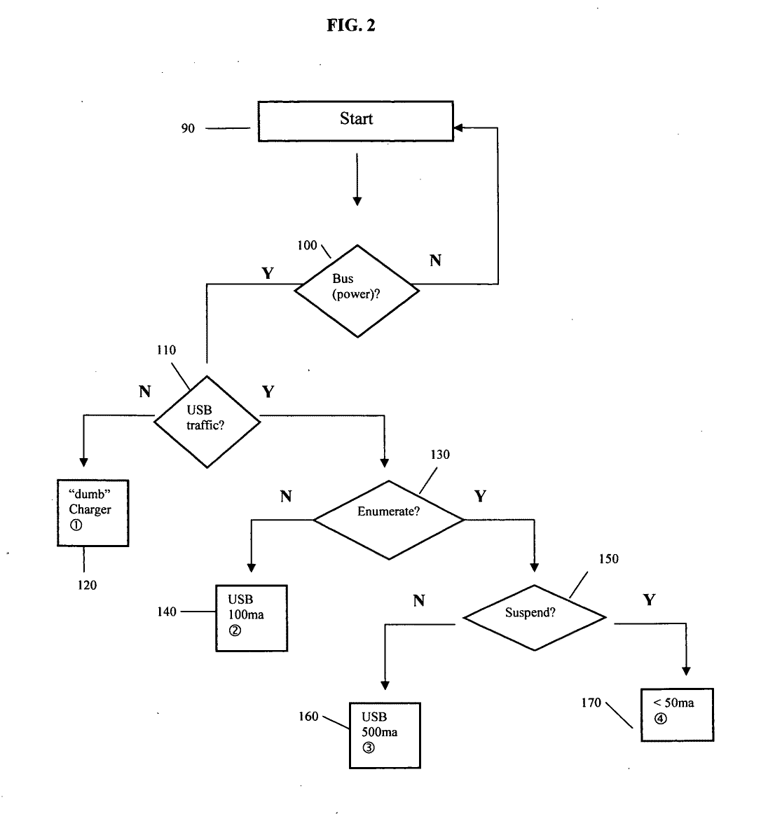

FIG. 2 is a flowchart of the power management function in terms of current used by the scanner's battery charger. There are four basic power states within the confines of the power management system. In start mode 90 the power management system waits for confirmation of ^{V}bus power 100. If none is present, the cycle returns to start and waits. If power is noted, the system tests for USB traffic 110. If there is no “traffic’ the charger assumes a “dumb” mode and draws low current (1 amp) 120. This is power state 1. If traffic is detected, enumeration or device recognition occurs 130. If no device is enumerated 140, the power mode limits the draw to 100 ma. This is power state 2. If a device which requires power is detected, the amount of draw is determined 150 and the charger will conduct accordingly to either power a device 160 (power state 3) or sit in a zero power draw mode 170 (power state 4).

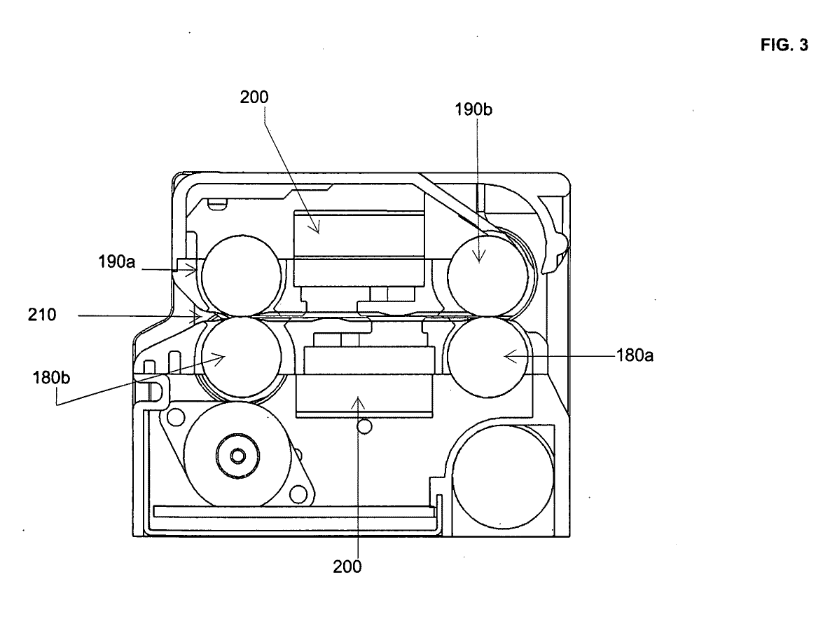

FIG. 3 is a view of the media transport arrangement. There are a set of entry and exit rollers 180 (feed rollers), and a set of support rollers 190. The drive or feed rollers 190b are essentially “floating” and are pressed against the support rollers by means of spring tension. The support rollers 180a are fixed within the scanner housing. Two CIS's (contact image sensors) 200 are located above and below the scan path, and are offset from one another to provide for a black background during scanning. Dual CIS's also provide the foundation for duplex scanning. Since the entire feed mechanism is secured on a pivot axis, the gap 210 in the paper feed is adjustable based simply upon the media inserted, e.g. the gap will automatically utilize the pivot axis to provide a gap proportionate to the media inserted while maintaining a straight paper path. This gap 210 may be up to 2 mm to accommodate media such as embossed credit cards or ID cards.

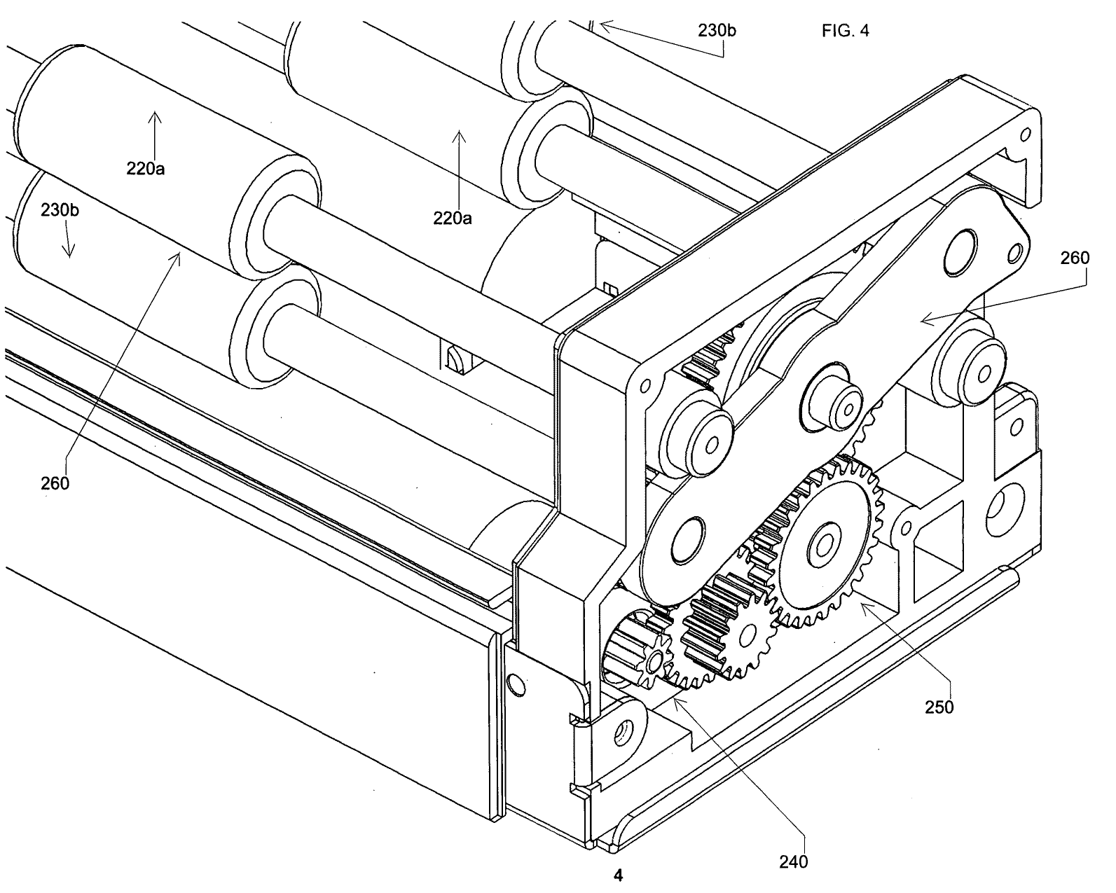

FIG. 4 illustrates the media transport arrangement in further detail. Again the drive 230b and support 220a rollers are shown. Motor feed gears 240 drive the gears attached to the fixed supports on the support rollers 250. When no motor torque is present, the roller sets are pressed together and no media may enter (hard stop) 260. Upon user insertion of media and alignment with paper sensors, the motor starts up and provides a force which releases the clamping effect via pivot of the axis point 270, creates a momentary gap, and allows media to be drawn through the scan path. This arrangement provides positive media grip with minimal motor torque requirements. For thicker media, the pivoting action of the roller assembly allows an appropriate gap, and once the media thickness is recognized, the rollers then close down on the media to effectuate positive grip and scanning through the remainder of the scan path. This gap creation and clamping process occurs in a few milliseconds and is not noticeable to the user.

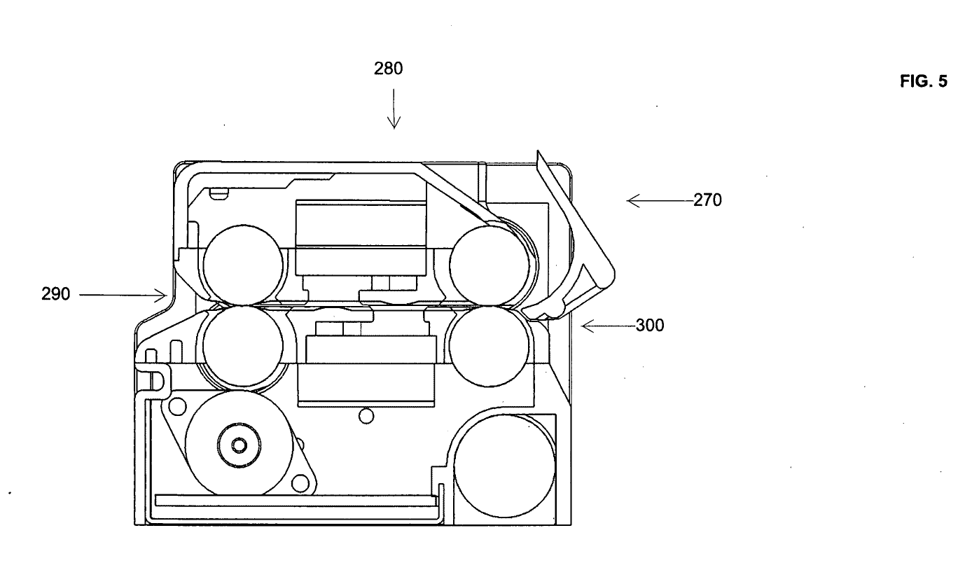

FIG. 5 shows the integrated paper return 270 in cross section. The paper return is integrated into the CIS top assembly 280. In the case of thicker media, the paper return will automatically move out of the way based upon the pivoting action described supra. Here, the paper return is shown in the open position 270. If a user wishes paper documents to be returned via the open return method, they simply open the paper return until it clicks in place. Closing the return is also secured so that the return remains either open or closed depending on the user's needs. Obviously a thicker media such as a credit card will not bend to be accommodated by an angled return mechanism, thus an automatic reverse is achieved by the inventive method so that the credit card is scanned and returned directly back from the point of entry 290, or it may exit the rear of the scanner as a result of the paper return automatically clearing the way. The size of the card is auto-detected by the sensors and once scanned, causes the credit card or ID card to be reversed so that the user does not have to retrieve the scanned card from the rear of the scanner 300. This method is simply a more convenient way to scan and retrieve a smaller media such as a credit or ID card. Rear exit 300 of other media may be achieved with the paper return in a closed position if a user chooses.

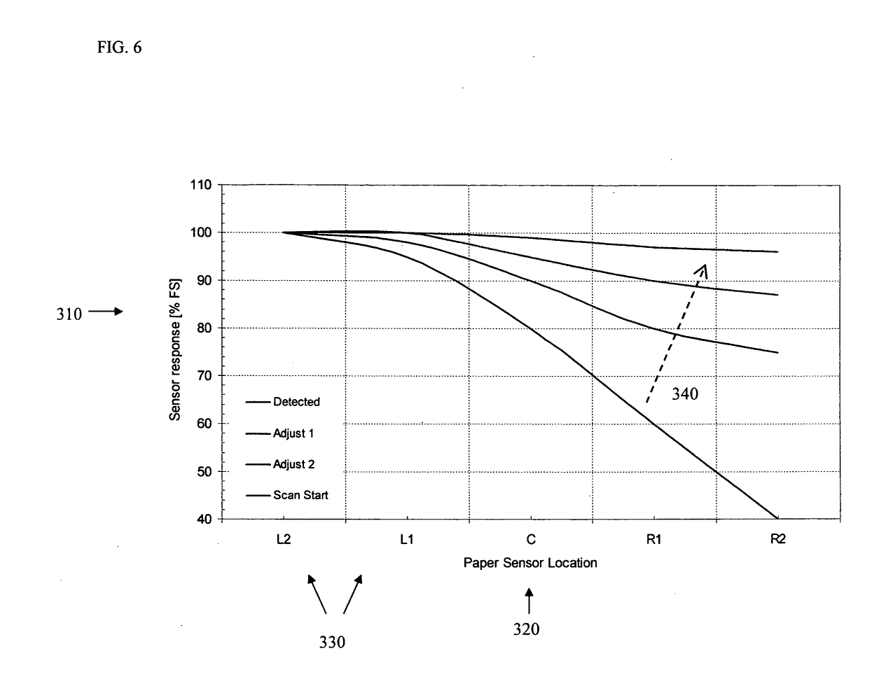

FIG. 6 is a graph representing the inventive “assisted de-skew” function. In FIG. 1 the front panel lights 50 were indicated as being the user's guide to visibly confirming straight insert of media. If media is inserted with a skew angle, not all of the paper sensors will be obscured. Thus, the media may be skewed to the right or left and requires adjustment. The readout circuit instructs the lights on the scanner to illuminate in relation to the angle of skew the user may be inserting the media with, e.g. media is inserted skewed to the right—the left alert light will illuminate to notify the user to angle the media slightly to the left. The user can then quickly adjust the angle of the media for a straight insert as directed by the skew lights. Once the media is inserted straight, no alert lights will be illuminated, and the scan proceeds. This is a quick and efficient process which is accomplished upon media acquisition, and is not reliant on software de-skew solutions. The graph is a simple representation of sensor response 310 in relation to media location as detected by the sensors 320. On the graph, L2, L1, C, R1 and R2 are representative of five analog detection channels 330 used to determine if media is inserted straight enough to scan. Sensor response is shown 340 in percentages based upon whether sensors are obscured as a user rotates the page. The directing illumination will function as described to alert the user in which angle to adjust media so the scan will proceed.

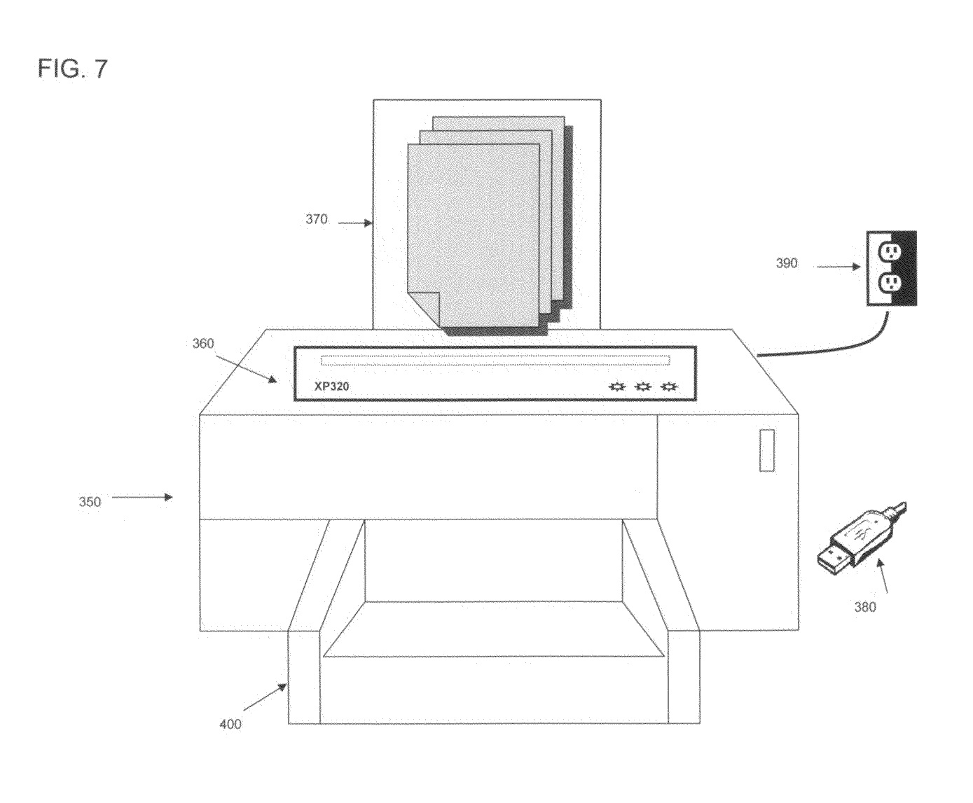

FIG. 7 is a fairly general example of an optional docking station 350. The docking station serves not only as a fixed base for the portable scanner 360 to reside and offer ADF (automatic document feed) 370 for multiple page scans, but also serves as a charger for the scanner batteries. The docking station should have a USB 380 uplink to the host and access to AC power 390. The ADF docking station includes an input tray and document collector 400. The station is equipped with its own motor/driver electronics and receives its control signals from the docked scanner. The docking station, as illustrated, may also be integrated with an MFP (multi-function peripheral) so that scanned items may be printed, copied or faxed from one device, thus eliminating footprint and clutter from a user's workspace.

1) A portable battery powered multi-media duplex scanner comprising:
a) Power source
b) USB connection for charging power source
c) Media input designed to accommodate varying media widths and thicknesses
d) Infrared paper sensors optimized to reduce stray light introduction, identification of media inserted, and skew thereof
e) Dual roller system optimized to aid in allowance of media thickness variation, grip thereof, and media control
f) A paper return optimized to return media forward or on a rear exit basis
g) A single motor to drive the media through the roller system and to aid in media thickness adjustment
h) Power management as conducted by the software and hardware of the scanner

2) A scanner as is claim 1 wherein the power source comprises lithium ion batteries capable of being recharged.

3) A scanner as in claim 1 wherein the USB connection comprises a device wherein one end of the connector is a USB type receptacle, and the other end an AC prong plug adapter or another USB connector able to connect to any power providing device.

4) Media input as in claim 1 wherein a standard size document, a credit card or ID card, or a compact disc may be accepted into the media input in thicknesses up to 2 mm.

5) Infrared paper sensors wherein said sensors will respond to being obscured by media and thereupon directing skew angle by alerting a user via lights illuminating in either a right or left direction so as to direct adjustment angle of inserted media.

6) A self power management method wherein the inventive software detects the charging source provided to said batteries and adjusts amperage draw so that the batteries are properly charged and discharged, and to effect minimal drain on the charge providing source such as a laptop computer.

7) The power management method of claim 6 wherein said method also comprises hardware detection of idle mode in scanner operation and subsequent voltage adjustment to low clock battery mode.

8) scanner of claim 1 also comprising a second input port which allows connectivity of external devices to supply power to, and charge for, said devices.

9) A dual roller system as in claim 1 wherein rollers are paired in fixed and floating configurations so as to allow a pivot axis to adjust to media thickness based upon mere insertion of the media.

10) A paper return as in claim 1 further comprising rear media exit, forward media exit when the return is in an open position, and automatic reverse return of credit card or ID card media.

11) An AC powered docking station wherein said station accepts the portable scanner and serves as a charging vehicle for the scanner batteries.

12) The docking station of claim 11 further comprising an integrated printer, copier or fax.

13) The docking station of claim 11 further comprising an automatic document feeder (ADF).
